(19) United States
(12) Patent Application Publication
(10) Pub. No.: US 2009/0264200 A1
(43) Pub. Date: Oct. 22, 2009

(54) ELECTRONIC CARD GAME

(75) Inventor: Erez SCHWARTZ, Tel Aviv (IL)

Correspondence Address: NIXON PEABODY, LLP, 401 9TH STREET, NW, SUITE 900, WASHINGTON, DC, 20004-2128, US

(73) Assignee: CDG ELECTROHEX LTD., Bney Brak (IL)

(21) Appl. No.: 12/429,147

(22) Filed: Apr. 23, 2009

Related U.S. Application Data
(63) Continuation-in-part of application No. 10/526,219, filed on Mar. 1, 2005.

(30) Foreign Application Priority Data
Oct. 9, 2003 (IL) PCT/IL2003/000810

(51) Int. Cl. A63F 9/24; A63F 13/00

(52) U.S. Cl. 463/40; 463/35

(57) ABSTRACT

An electronic game platform is described. The electronic game platform includes a master, multiple bases and multiple cards. The cards are electrically connectable to the bases, which are electrically connectable with the master. The bases transmit identification data that is encoded in the cards and user input to the master, which runs the game. The master also provides visual and/or audio feedback to users at the bases and provides power to the bases.

### CROSS-REFERENCE TO RELATED APPLICATIONS

The present application is a continuation-in-part of U.S. application Ser. No. 10/526,219, entitled “ELECTRONIC CARD SYSTEM AND METHOD,” which claims priority to PCT Patent Application No. PCT/IL2003/000810, filed on Oct. 9, 2003, and which claims priority to U.S. provisional application Ser. No. 60/417,624, filed on Oct. 11, 2002, the entireties of which are hereby incorporated by reference.

### BACKGROUND

1. Field

The subject invention relates to an electronic card game, components of the electronic card game and methods associated with the electronic card game.

2. Related Art

Collectable card games have become increasingly popular. These card games are strategy games using cardboard cards and a set of rules for playing the game with the cards. Typically, each player buys randomly arranged card packages (sometimes called boosters). The cards can be traded with other players to form a synergic combination, which is used in the game to fight other players. Exemplary card game brands include “Magic,” the “Gathering,” and “Yo-Gi-Ho!” While these card games offer a basic strategic game at a relatively low cost (˜10), the games are relatively complex and difficult to master. Players are required to understand and remember the complex game rules, perform many calculations and remember many ritual-like actions in order to maintain the game.

Board games, such as, Monopoly, Risk, Clue, Axis & Allies, Settlers of Catan and Twilight Imperium, are popular among board game players. Board games vary in complexity from simple to extremely difficult and therefore appeal to different tastes, and typically cost from about $10 to over $100. These board games, however, lack the action stimulus of video games and, therefore, are less successful with today's children. In some of these board games, the playing strategy is complex, managed by an extensive and convoluted system of rules described in long manuals. Most board games are more time consuming then other entertainment solutions and average well over an hour of playtime and can even reach four hours for some of the strategy board games. As the game becomes longer, the moments for climax and excitement are delayed, making it harder to compete with the instant satisfaction of video games.

Gaming consoles are powerful computers that have advanced graphic processors for playing video games. The latest gaming consoles also have Blu-Ray drives, support wireless communication and have a connection to the internet. The consoles are connected to a television screen, and the games are activated by a set of controllers connected to the consoles. The leading consoles in the market today are Sony PlayStation 3, Microsoft Xbox 360 and Nintendo Wii. The games vary in type and are sold separately for each gaming console system on disks. The consoles are very expensive, ranging from $350 for Wii and up to $700 for the most powerful version of PlayStation 3, and the games, which are individually purchased, typically cost at least $50 each. Most of these games are either solo games (one player) or side by side games (two players both stare into the same screen or play in the same virtual environment through the web). That is, there is no direct human interaction and no real social value when players play these games. The size of the consoles, and the need for a television screen and an electrical outlet make these devices stationary and limit their use to home environments only.

Handheld gaming devices are small, portable versions of the gaming consoles. These handheld devices typically have a small LCD (liquid crystal display) screen, a set of control buttons and an internal rechargeable battery. Some of these devices support IR (infrared) connection, wireless communication, a touch screen, music/movie playing capabilities and various add-ons. The leading examples are the Nintendo Double screen (DS) and the Sony PlayStation Portable (PSP). The price of these handheld devices typically ranges from $˜120 for the DS to over $˜150 for the PSP, and a single game typically costs $20-50. While the games are portable they are typically limited to single player games in which the user stares at the display (i.e., without any social interaction).

Attempts have been made to create an interactive card game that combines the collectible cards with the gaming consoles. To play these games, a card reader is required as an add-on to the gaming console. The card is inserted into the card reader, which reads the card and uploads the data into a video game that is no different from other video games played on the gaming console, except for its ability to modify the game with cards. Thus, these combined card/gaming console interactive card games suffer from the same drawbacks as the gaming consoles.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

According to an aspect of the invention, an electronic card game is described. The electronic card game is configured to store the rules of the game, parameters of the game, and monitor user inputs to provide an improved gaming experience. Advantages of the electronic collectible card game include, for example, the portability of the game platform, the variety of games playable with the electronic game system, the knowledge of the game stored in the electronic card system, the variety of strategy levels available for game play and the improved social interaction.

According to an aspect of the invention, an electronic card game system is described that includes a master controller; a plurality of bases, each of the plurality of bases connectable to the master controller or one or more of the plurality of bases; and a plurality of cards, each card connectable to respective ones of the plurality of bases.

Each of the plurality of bases may include a processor operable to receive a transmission from another base and relay the transmission.

Each of the bases may include connectors configured to receive power from the master and concurrently or alternatively receive power from another base.

Each of the plurality of cards may include an identifier readable by the bases.

Each of the plurality of bases may include an identifier reader to read the identifier on each of the plurality of cards and wherein the base is configured to relay the identifier to the controller.

The identifier may be one of optical, resistive paint an RFID tag and conductive shorts.

The master controller may store at least one of data regarding each of the plurality of cards and rules for playing the electronic card game.

The bases may be configured to at least one of relay game commands to the master controller, receive the game commands and calculates consequences and indicate consequences audibly, visually, or audibly and visually.

According to yet another aspect of the invention, a master card for an electronic card game is described that includes a rules data memory to store a plurality of rules for the electronic card game; a parameter data memory to store parameter data regarding each card associated with the electronic card game; and a game engine coupled with the rules data memory and the parameter data memory to: detect slave cards coupled with the master card, receive parameter information from the slave cards, receive card identification information from the slave cards, receive user input data from the slave cards, process the user input data using at least one of the plurality of rules and the parameter data, identify a result, and issue an indication of the result.

The game engine may further transmit the result to at least one of the slave cards.

The master card may further include a communications link coupled with the processor, the communications link configured to allow for communication between the master card and the slave cards.

The master card may further include a communications link coupled with the processor, the communications link configured to allow for communication between the master card and an external computing device and wherein the external computing device is selected from the group consisting of a personal computer, a server and a mobile device.

The master card may further include a user interface coupled with the game engine, the user interface configured to receive user input wherein the user interface comprises at least one button.

The user interface may include an indicator to provide information to a user, and the indicator may include a visual indicator, an audio indicator or a visual indicator and an audio indicator.

According to a further aspect of the invention, a slave card for an electronic card game is described that includes a housing configured to receive a playing card; an identification reader in the base structure to identify the card; a plurality of electrical connectors to electrically connect the base structure with a master controller or another base structure; and a user interface on the base structure.

The slave card may further include a processor structured to communicate with the master controller.

The user interface may include one or more of at least one button and a plurality of indicators, and the plurality of indicators may include visual indicators, audio indicators or visual indicators and audio indicators.

The identification reader may include one or more of an optical reader and electrical contacts.

The electrical connectors may include at least a power line and a data line.

The playing card may include an action figure.

According to another aspect of the invention, a master card for an electronic card game is described that includes a housing; a controller in the housing; and a plurality of electrical connectors coupled with the controller, the plurality of electrical connectors to electrically connect the master card with a plurality of bases, the electrical connectors configured to supply power and data to the bases.

The master card may further include a user interface on the housing.

Each of the plurality of electrical connectors may include at least a power contact, a ground contact and a data contact.

According to yet another aspect of the invention, a system is described that includes a plurality of cards; a plurality of bases, the plurality of cards configured to be coupled with a respective plurality of the plurality of bases; a master controller, the plurality of bases configured to be coupled to the master controller, the master controller configured to exchange data with each of the plurality of bases, and wherein the plurality of bases are configured to receive user input at one of the plurality of bases and communicate the user input to the master controller, and wherein the master controller is configured to process the user input at the master controller based on at least one rule stored at the master controller to determine a result and provide an indication of the results

The master controller may transmit the result to at least the one of the plurality of bases.

Each of the plurality of cards may include an identification code and wherein each of the plurality of bases comprises an identification reader.

The master controller may include a user interface and each of the plurality of bases may include a user interface, the plurality of bases configured to receive the user input at the user interface of the plurality of bases.

According to a further aspect of the invention, a playing card is described that includes a planar card; an identification code on a surface of the card; and a graphical design on an opposite surface of the card.

The identification code may be optically recognizable or include conductive shorts.

The graphical design may include game data associated with the playing card.

The identification code may be configured to provide data about the playing card to a master controller coupled with the playing card.

The surface of the card having the identification code may further include a graphical design.

### BRIEF DESCRIPTION OF THE DRAWINGS

The accompanying drawings, which are incorporated in and constitute a part of this specification, exemplify the embodiments of the present invention and, together with the description, serve to explain and illustrate principles of the invention. The drawings are intended to illustrate major features of the exemplary embodiments in a diagrammatic manner. The drawings are not intended to depict every feature of actual embodiments nor relative dimensions of the depicted elements, and are not drawn to scale.

FIG. 1 is schematic view of two electronic cards in communication with one another in accordance with one embodiment of the invention.

FIG. 2 is cross-sectional view of an electronic card in accordance with one embodiment of the invention.

FIG. 3 is schematic view of a game configuration comprising a plurality of cards communicating with each other in accordance with one embodiment of the invention.

FIG. 4 is top view of an electronic card in accordance with one embodiment of the invention.

FIGS. 5-7 are schematic views illustrating possible configurations of the game using a plurality of connected electronic cards in accordance with one embodiment of the invention.

FIG. 8 is a schematic view illustrating communication channels between the electronic cards in accordance with one embodiment of the invention.

FIG. 9A is a top view of a master card in accordance with one embodiment of the invention.

FIG. 9B is a perspective view of the master card of FIG. 9A in accordance with one embodiment of the invention. The master card may function as and may be referred to as a console card, main control card, etc.

FIG. 10A is a block diagram of the master card in accordance with one embodiment of the invention.

FIG. 10B is a block diagram of an exemplary functional system of the master card.

FIG. 11 is a top view of a base having a card placed thereupon in accordance with one embodiment of the invention. Generally, the combination of a base with a card may be referred to as a “game tile”, although, sometimes it is referred to only as “base” or “base card”.

FIG. 12A is a front view of exemplary removable cards for the base of FIG. 11 in accordance with one embodiment of the invention.

FIG. 12B is a back view of an exemplary removable card for the base of FIG. 11 in accordance with one embodiment of the invention.

FIG. 12C is a schematic view of exemplary identification tag configurations in accordance with one embodiment of the invention.

FIG. 12D is a perspective view of a base having a three-dimensional card in accordance with one embodiment of the invention.

FIG. 13 is a schematic view illustrating placement of the removable card on the base in accordance with one embodiment of the invention.

FIG. 14A is a perspective view illustrating connection of bases to a master in accordance with one embodiment of the invention.

FIG. 14B is a top view illustrating direct and indirect connection of several bases to a master.

FIG. 15 is a block diagram illustrating a system having a master connected to several bases in accordance with one embodiment of the invention.

### DETAILED DESCRIPTION

An electronic game platform that allows a user to play a collectible card game without having to memorize all of the game rules or perform tedious calculations is described. The electronic game platform includes a master, bases that are connectable with the master or one or more other bases, and collectible cards insertable into the bases. The electronic game platform may also, optionally, include expandable memory cards, a personality module, a game website, and the like. The cards include an identifier which is readable by the base. The base transmits the card identifier information to the master, which creates a game plot according to the game rules, base position, card attributes and player feedback. The electronic game platform can support many different games by updating the software at the master and different content by changing the playing cards. The electronic game platform promotes direct social interaction during the game, in addition to the social interaction associated with exchanging cards before and after the game.

In one embodiment of the present invention, the game includes a plurality of cards 1. Each card 1 may be about half a centimeter thick. Each card may include a controller, one or more communication devices, user input devices such as push buttons, sound producing devices, and one or more light emitting diodes or LCD or similar display methods.

The cards 1 are configured to be laid out such that the cards 1 can be joined with other cards. In one embodiment, the cards 1 are rectangular and can be located on a bi-directional pattern adjacent to each other, or in a 3-D implementation. The cards may include a controller and communication devices.

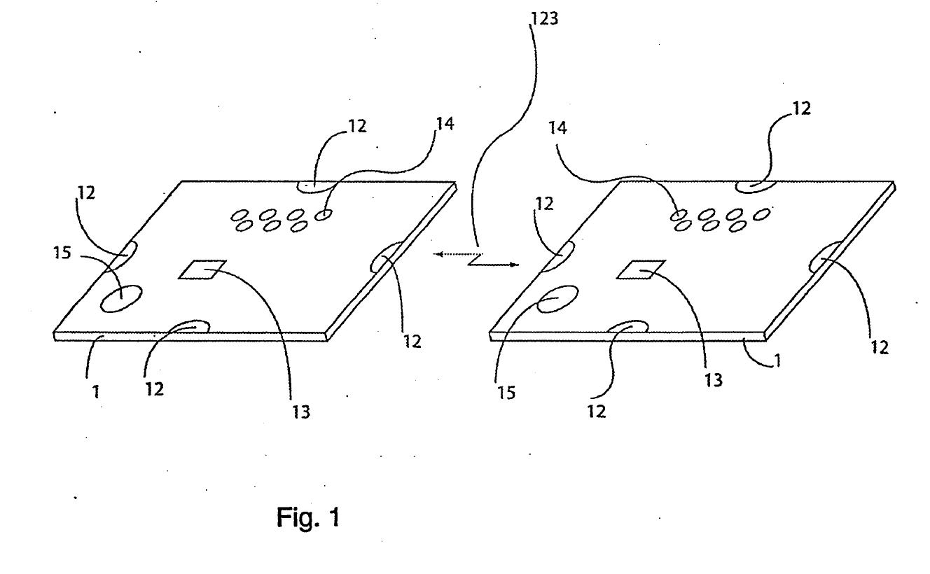

FIG. 1 illustrates two cards 1 in accordance with one embodiment of the present invention. The cards 1 may communicate with one another through one or more communication devices 12 contained in each card.

The communication device(s) 12 on a card 1 may either use an optical, radio frequency and/or direct contact communication (ohmic) link to communicate with a corresponding communication device 12 on a second card nearby. Communication devices of sufficiently small dimensions to fit on or within a card are well known in communications. For example, the communication device may include a LED as an optical transmitter, a photo sensor as a receiver, and single chip coder/decoder to: (1) convert outbound data into modulated electric pulse to drive the LED, and (2) to convert the output of the photo sensor into an inbound data stream.

FIG. 1 thus illustrates one configuration of the game, comprising two electronic cards 1 with communications devices 12 therebetween. The communications devices 12 of two adjacent cards form a communication channel 123. The manual input device 13 in each card may include push buttons, a keyboard and/or keypad, etc. The display 14 may include Light Emitting Diodes (LEDs), LED matrix, Liquid Crystal Display (LCD), etc. The sound generator 15 may include a loudspeaker, a piezoelectric device, etc.

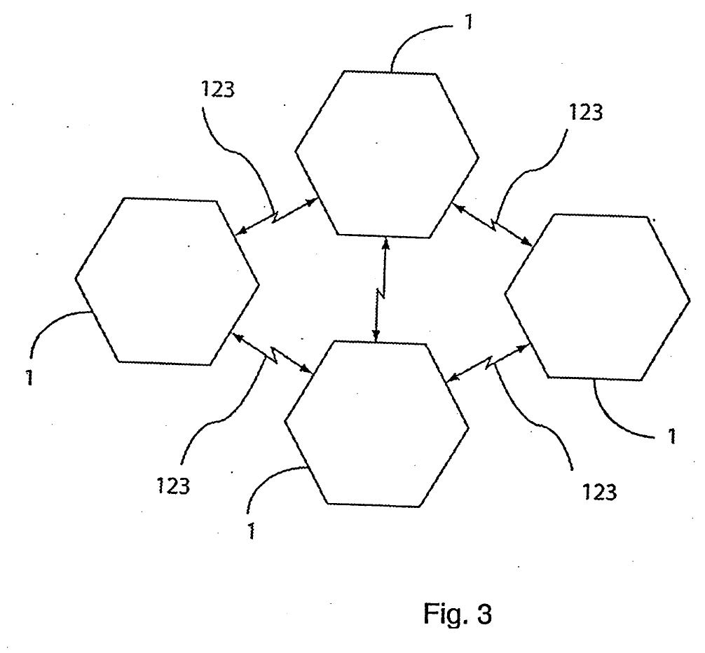

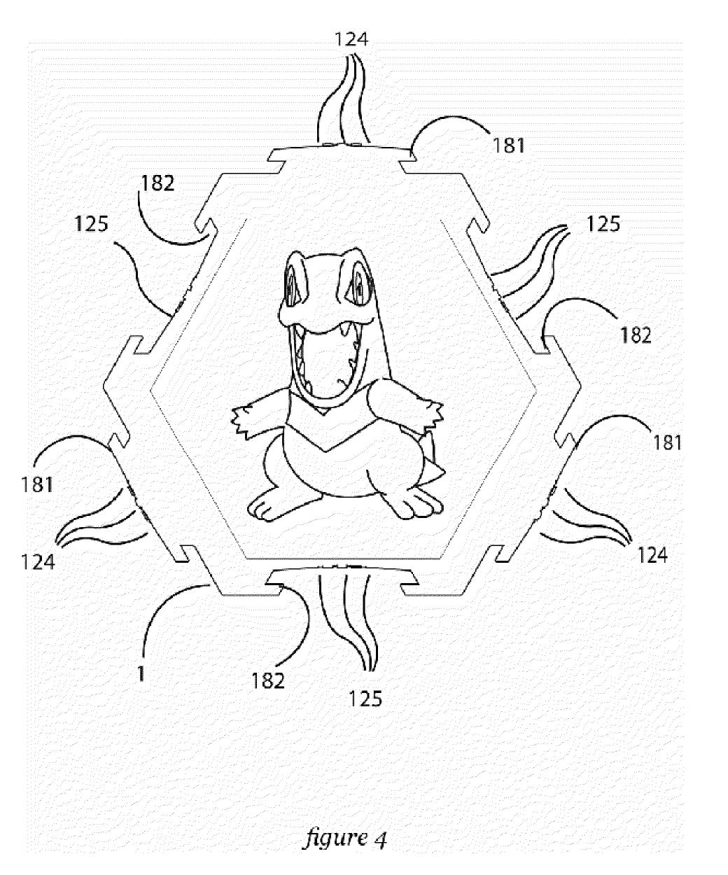

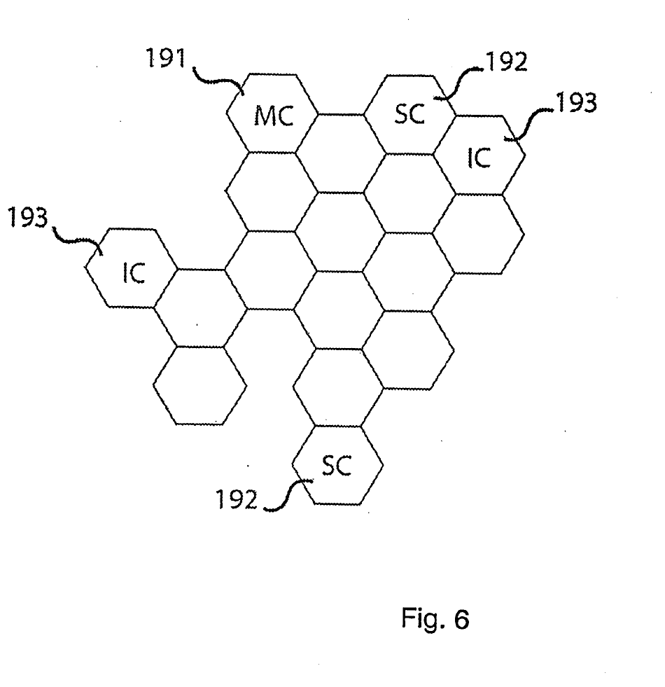

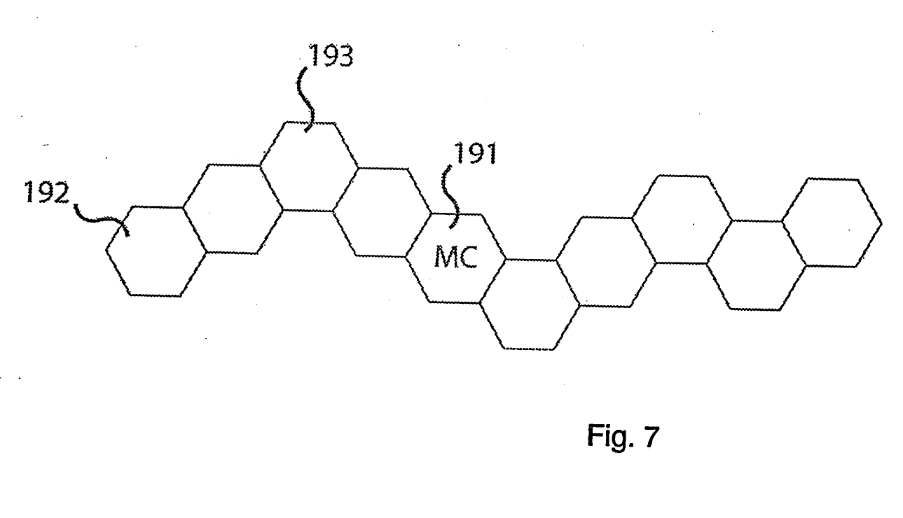

In the embodiment as illustrated, the electronic card 1 is square shaped, this allowing to connect cards by placing them close to each other in two dimensions, as further illustrated in FIGS. 3, 5 to 8. The cards may have other shapes that allow grouping the cards in two dimensions, such as a hexagonal shape (See FIG. 4), triangular or another bi-directional shape. In other embodiments, the cards are connected so that they may be connected to each other in a 3-D arrangement.

The sound generator can be installed in all the cards or in only some of the cards.

Electrical power can be transferred between cards. Data and power can be transferred over common pins between cards.

The cards may further be configured for connection to a personal computer for control, upgrade and/or sound generation.

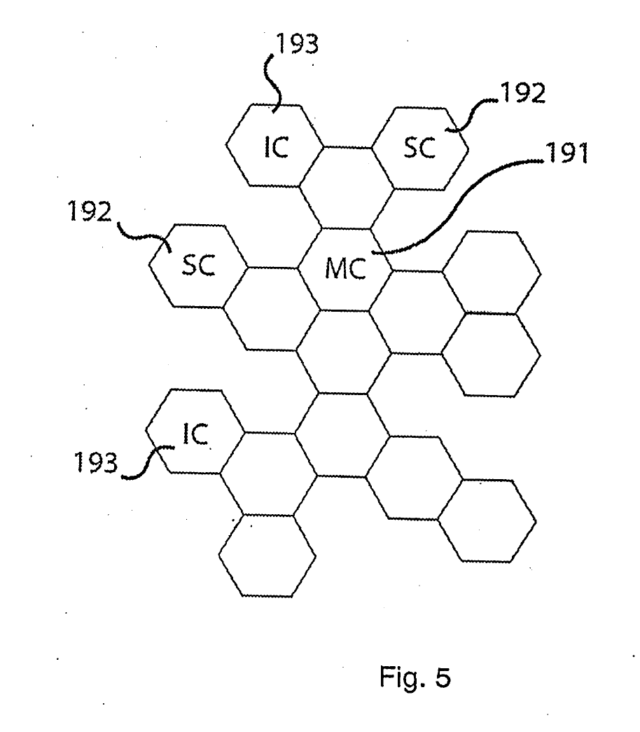

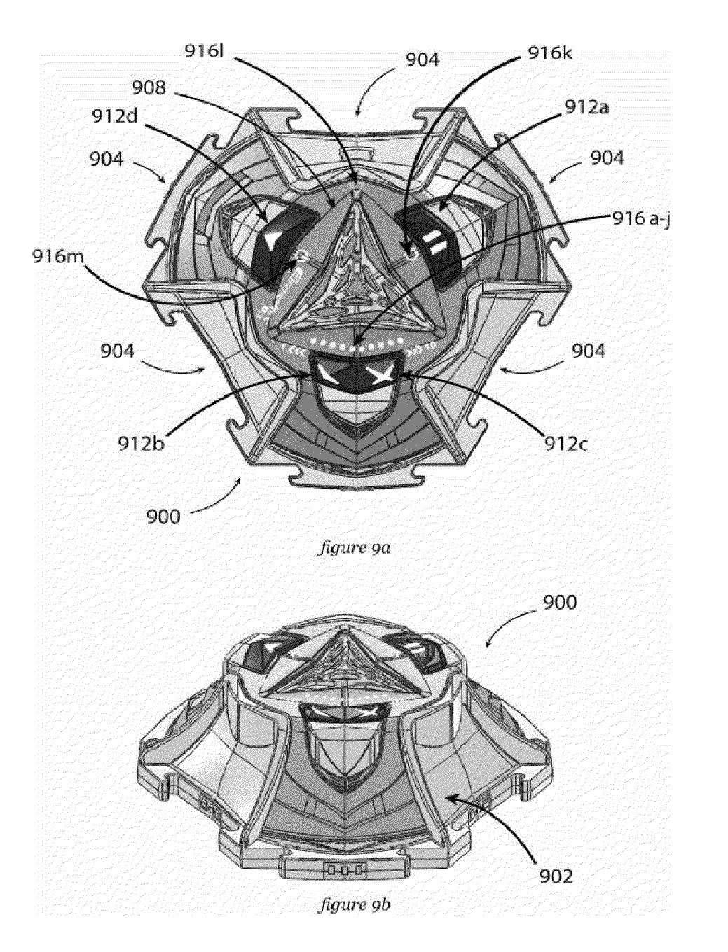

In one embodiment, each card 1 has a controller and there are interactions between cards to form a distributed computer system as the cards are placed next to each other. There is no central controller in one embodiment of the game. In another embodiment, one card is the master, its controller controlling the game, whereas the other cards are slaves with minimal computing power. The latter (master/slave) structure is further detailed with reference to FIGS. 5, 6, 7 and 8. In yet another embodiment, a master card has a controller, which is connected to several bases that do not have a controller; collectible cards are insertable into the bases, which communicate information identifying the cards to the master. (See FIGS. 9-14).

Throughout the present disclosure, it is to be understood that, unless otherwise stated, the game methods and game structure embodiments may apply to both of the two above-detailed embodiments.

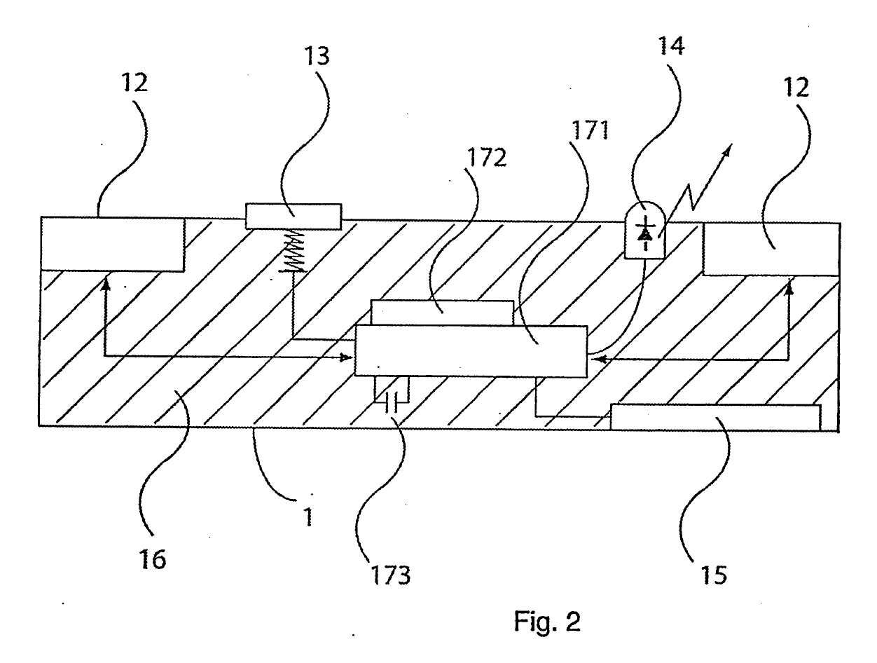

FIG. 2 illustrates a cross sectional view of an electronic card 1 according to an embodiment of the present invention. A controller 171 within the card may contain logic circuits, programmed with certain functional logic (e.g. game logic and/or rules—in the event the card is used as a game card). The controller 171 may contain memory and/or may be connected to non-volatile memory 172, such that certain values associated with the function of the card may be stored in the non-volatile memory 172.

In one embodiment, memory is only installed in the master card. In another embodiment, memory is also installed in slave cards. This may increase the cost of the slave cards, however it may enable each card to preserve its individual status, which may change during the game. Conversely, the master may have memory, and the bases are configured to transmit a card identifier form the card to the master.

The controller 171 may receive a user input in the form of an electric signal produced when a user engages a button 13 on the card. Electric buttons/inputs/actuators 13 are well known, and any such device, known today or to be devised in the future, may be used with the present invention.

Upon engaging a button 13 on a card 1, a signal to the controller 171 may activate the controller 171 and may cause the controller to produce a communication signal in accordance with some predefined logic or rules. The communication signal may be transmitted by one or more of the card's communication device(s) 12.

In addition to transmitting communication signals to other cards, the controller 171 on a first card 1 may also receive a communication signal from a controller on another card. The other card may or may not be the same card to which the first card transmitted a communication signal. In some embodiments, a card will both transmit and receive data when a user activates the controller.

Each card may transmit information to the master card, which controls the game serving as its “brains”. As each player pushes a button on a first slave card to indicate an attack, then on a second slave card to designate its target, the apparent impression is of communications between the two slave cards. Actually, each slave card relays the input information to the master card, which decides the outcome of the move and activates output devices accordingly. The players, however, get the impression of direct interactions between two slave cards.

The communication signals exchanged by two cards 1 may relate to any one of a number of possible transactions permitted in the course of the game. For example, the data exchanged may represent digital money, personal contact information, game-related data, etc. Information relating to, or derived from data received by a card may be stored on the card's non-volatile memory or on a master card's memory.

The exchanged data may be used to determine the location of the cards with respect to each other. In one embodiment, this determination is made at the master card. The location of the cards may be used, together with the rules of the game, to decide the outcome of each move, successes and losses of players, and to declare the winner.

A card may also include one or more light emitting diodes (LED) 14 and one or more sound producing devices 15 (e.g. piezoelectric speaker). The LED 14 and/or sound producing devices 15 may be activated by a card's controller 171 to communicate with a user. Information relating to the condition of the card 1 and information relating to the status of a transaction with a second card 1 may be communicated to a user of the card as a series of lights flashes and/or sounds.

In one embodiment of the present invention, each card 1 may represent a character in a role-playing game such as Dragons and Dungeons.

Statistics and/or status information about a character may be stored on a card's non-volatile memory 172. The game logic for the role-playing game may be contained in the controller 171 and/or the non-volatile memory 172.

When using a master/slave embodiment, a slave card may include generic base card which holds and supports a detachable cover card. In this case, the cover card provides two elements: (1) graphics which exclusively expresses and describes a specific character, one out of hundreds or thousands characters; and (2) a corresponding electronic (coded) description thereof that can be identified by any slave card when attached to it.

The base card may be about 3 mm thick, and the detachable cover card may be thinner, about 1 mm, or about ¼ to 1 mm thick for example.

Examples of possible embodiments of the game: (1) the slave cards each contains a personality of that card; and, (2) the slave bases are generic and identical, however they allow for mounting coded detachable thin cover cards thereon, with the detachable cover cards storing each a unique personality and/or features.

The codes in the cover cards and slave cards may include a bar code, electrical contacts, a smart card, resistivity, mechanical lugs, etc. Various codes, e.g., a 10 bit or 32 bit code may be used.

A sound generator 15 is located in the master and/or slave card, to emit sounds into the ambient. A communications devices 12 may be located within the card 1.

The electronic controller 171 may include a controller, microcomputer, microcontroller, etc. or the like to control the operation of the device, the interaction with the user through LEDs 14 and speakers 15, and the communications with other cards through the communications devices 12.

The memory 172 may include, for example, one or more of RAM, ROM, EPROM, EEPROM, Flash memory, etc. In one embodiment, the memory may include a replaceable module with additional programs and/or description of the character emulated in each slave card or detachable thin cover card. The characteristics of that character may be changed by replacing the memory card. A nonvolatile memory is required in this case.

A battery 173 provides electric energy to the card(s), and may be a rechargeable battery, with provisions for charging from a wall outlet, USB port, etc. The battery 173 is optional—electrical energy may be supplied from an adjacent card, or from one card to all the other cards connected together to form the game. A battery in each card saves the need to transfer power between cards, however using a common source of energy saves the need to periodically replace or charge a plurality of batteries and more—it lowers significantly the cost of each slave card and makes it even more affordable to the user.

A substrate 16 may be made of paper, cardboard, plastic, wood or another material.

As two or more cards 1 are brought into proximity with each other (as shown in FIG. 3), and each card is activated, the cards may communicate with one another through communication channels 123 and may engage in a series of transactions or engagements simulating a game.

An example of a possible game method is detailed below (a game logic table), which may be used to implement a role-playing game on a series of cards according to one embodiment of the present invention.

The information stored on a card's non-volatile memory may include such parameters as the card's inherent value or strength in certain areas. For example, on a card representing a “Prince Character”, the card may store different values in different memory areas representing different game-related attributes such as for example: fighting=5, commerce=7, charm=15, etc.

Components of the game in this example: 1. One master card; 2. Five slave cards for each player. Each slave card may accept any of tens of detachable thin cover cards, each coded with specific characteristics.

Examples of two game configurations: 1. Each personality is fixedly attached to a slave card or in other words: each slave card holds non separate personality as a part of it. 2. The detachable thin cover cards are separate from the slave cards and may be attached to slave cards by the players. In both configurations: Each time a slave is connected to the game, its code is transferred to the master card, which recognizes it and continues the game accordingly. Both the slave characteristics and its location affect the game.

### Game Method #1

1. The game may be played by one or more participants. The game may include a plurality of rounds, with a turn for each participant in each. Between the rounds, additional activities may be allowed, for example adding or removing cards from the game, thereby changing its configuration.

2. At the beginning of each game, a setup procedure is performed. Each player may add one or more cards to the game board. The game parameters are set up, including various values such as the number of players, etc. The initial values may include by default the values of the previous game. The master card may automatically recognize the game configuration by communicating with the other cards connected in the game. Each card allows signals to communicate between cards adjacent thereto, such that all the cards are functionally connected.

3. The master card detects any addition of a new card and automatically proceeds to the next player. A voice indication may acknowledge the card connection. Pressing the “Start” button on the master card starts the game.

4. During the game, each player can only operate cards during his turn. There may be a predefined time period allocated to each player. After each player's turn, the game points to the next player. Alternately, a dedicated button switches the system to the next player.

5. Each card may have a set of parameters, defining its status. At the beginning of the game, each card may be set to a default value. At some cases, a card may be declared dead or inactive. In this case, a corresponding indicator is activated, for example a LED turning OFF. An inactive card will not respond to a participants commands, however it remains active electronically, for example to relay signals between adjacent cards or to be reactivated by the master card. It may participate in display effects as initiated by the master card.

6. After each round in the game, according to the rules of the game as stored in the master card, players may have an opportunity to add cards, replace cards or activate dead cards. The rules may forbid removal of cards, permitting only their replacement. The master card supervises the activities performed by the participants, including the activation of each card, as well as cards removals, additions or replacements. If a forbidden activity is performed, the master card will give an adequate indication and may activate/deactivate each card according to the rules of the game.

7. The system may distinguish between card additions during setup versus additions between rounds, and may activate different routines in each case. In the former case, the parameters in all the cards may be set to their default values, whereas in the latter case only the additional cards may be set to their default values. A card being reactivated may return to its last known state, with its corresponding values.

8. The topology of the game (the location of the cards relative to each other) affects the operation of the game. The parameters affected by the topology may include the game speed, the routines activated, the relative performance of characters, etc. Thus, the game method is topology-sensitive.

9. The game is finished when only cards belonging to one player remain active on board, or when the Master Card is “captured” by one of the players, or when all the player's cards become inactive. Other criteria for game end may be defined as well.

10. The game may include various sound and/or visual effects, which may be activated from the Master Card, responsive to player's actions. Such effects may include concurrent activation of display devices in a plurality of cards, and/or concurrent generation of sounds in various cards. Such effects may dramatically enhance player's involvement in the game and their pleasure therein.

Game Method #2

1. Setting up the game by connecting cards to each other in a bi-dimensional pattern. The cards may correspond to one or more participants.

2. Initial system set-up. The master card communicates with all the connected cards, learning the present topology. The rules of the game may include fixed rules and additional rules defined by the topology. Alternatively, the actual rules of the game are affected by the topology.

3. Playing the game, wherein each player in his/her turn activates controls in one or more cards.

4. The master cards responds to each player's actions by: a. checking their compliance with the rules of the game, accepting legal actions and rejecting illegal actions. b. responding to acceptable actions with audio/visual responses and/or changing the status of the various players and their cards, according to the rules of the game.

5. Playing the game, wherein each player in his/her turn adds, removes, activates and/or deactivates their cards.

6. The master card responds to each player's actions by: a. checking their compliance with the rules of the game, accepting legal actions and rejecting illegal actions. b. responding to acceptable actions with audio/visual responses and/or changing the rules of the game and the status of the various players and their cards, according to the rules of the game.

7. Repeating steps 3 to 6 until a winner is declared, according to the rules of the game.

In addition to storing a card's inherent value(s), the non-volatile memory may also be used to store data related to a card's condition, score and/or status. For example, in the context of a money card, the non-volatile memory may store digital data representing digital currency.

In the context of a game card, using Dragons and Dungeons for example, the non-volatile memory may store a card's score. For example, if a particular card has a history of many favorable engagements with other cards, and thus has collected many points during each engagement, the large number of points collected by a card may be stored in the card's memory. Conversely, if a card has been engaged in a number of losing engagements with other cards, the low score may also be stored in the card's non-volatile memory. The low score may be stored in the master card, which will identify each coded slave card to join the game. In this case, there is no need to store game information in the slave cards.

FIG. 4 details the structure of an electronic card 1, hexagonal in this embodiment. Each side of the card may include either male mechanical holding features 181, or corresponding female mechanical holding features 182. Furthermore, each side may include a communications device, in this embodiment either male ohmic contacts 124 or corresponding female ohmic contacts 125. Alternatively, each side may include both male and female ohmic contacts.

The male contacts 124 may be spring-loaded, to allow easy assembly of cards together, wherein these contact protrude into their female counterparts 125. The three contacts may include Ground, In/Out communications and electrical power (DC), respectively.

The electrical power contact is optional, in case it is desired to transfer electrical between adjacent cards, or from one card to all the other cards connected together to form the game. It is not needed when a battery is included in the slave, or when the data contact is also used to transfer power.

The illustration on the upper side of the card 1 may refer to the character emulated by that card, etc. Furthermore, the upper side of card 1 may also include manual input devices, a display, a sound generator, etc.

In one embodiment, there are two basic types of cards, the master card and the slave card. The master card controls the game, communicating with all the slave cards. Slave cards may include each a detachable thin cover card. The game parameters stored in the master and/or in the slave cards may include the characteristics of each slave card.

An Example of a Game Logic Table

| Name | Life | Energy | Hit | Defense |
|---|---|---|---|---|
| Wolverine | 100 | 150 | 15 | 11 |
| Cyclops | 70 | 100 | 12 | 11 |
| Jean Grey | 60 | 80 | 12 | 8 |
| Rogue | 90 | 120 | 11 | 9 |
| Storm | 90 | 130 | 6 | 9 |
| Mystique | 70 | 80 | 11 | 9 |
| Spiderman | 140 | 140 | 13 | 12 |

Each slave card or detachable thin cover card may have a unique identity number.

FIGS. 5, 6 and 7 illustrate three possible configurations of the game using a plurality of connected electronic cards. In the embodiments illustrated in FIGS. 5, 6, 7 and 8, one card is the master, its controller controlling the game, whereas the other cards are slaves with minimal computing power. The cards themselves may be each of one of several types, as indicated: a master card 191, an active slave card 192 or an inactive slave card 193.

One of the cards may be a master card, including devices for communicating with the other cards and for controlling the game. In this case, the other cards may be slaves, controlled by the master card.

In one embodiment, each slave card is made of one piece. In another embodiment, each slave card comprises a base and a detachable cover, wherein the cover holds the identification and specific properties (e.g., personality, accessory, features, etc.) for the slave card.

Master card: belongs to one of the players and controls the game, communicating with all the slaves of all players equally. The master card may hold all the necessary hardware, software, processor, memory, loudspeaker, energy source, LED's, push buttons, etc., to manage and support the whole game. The master card has the same two dimensional size of the slave cards so it can fit in any location in the overall layout of the slave cards. The master card may be higher with respect to the slave cards, so it can contain all the elements described above to support the game.

Slave card: each belongs to one of the players; they are low cost, allowing players to accumulate a plurality thereof. The “personality” of each slave card is contained in the specific slave card itself, then it is no need for the detachable cover cards in the game.

Detachable thin cover card: each belongs to one of the players; they are very low cost, allowing players to accumulate easily a plurality thereof. In case the “personality” of each slave card is contained in the detachable thin cover card, the slave card would be generic, without uniqueness or any identification and is used only as a platform to hold and support the detachable thin cover card.

In this case, the detachable thin cover card provides two elements: 1. graphics which exclusively express and describe a specific character, one out of hundreds or thousands characters; 2. the detachable thin cover card holds corresponding electronic (coded) description thereof that can be identified by any slave card when attached thereto.

In one embodiment, the sound generator is only installed in the master card. Alternately, they may also be installed in slave cards.

The master card controls the game and declares a winner. It may activate or deactivate the slave cards and may generate the various sounds and visual effects. The power source is located in the master card, with power being transferred to the slave cards through interconnections therebetween.

The user can connect the master card to a PC to transfer voice files, upgrades from the manufacturer via the Internet or from media bought from a store. The customer can buy tiny memory devices from toy stores, for example, to be installed in the master card.

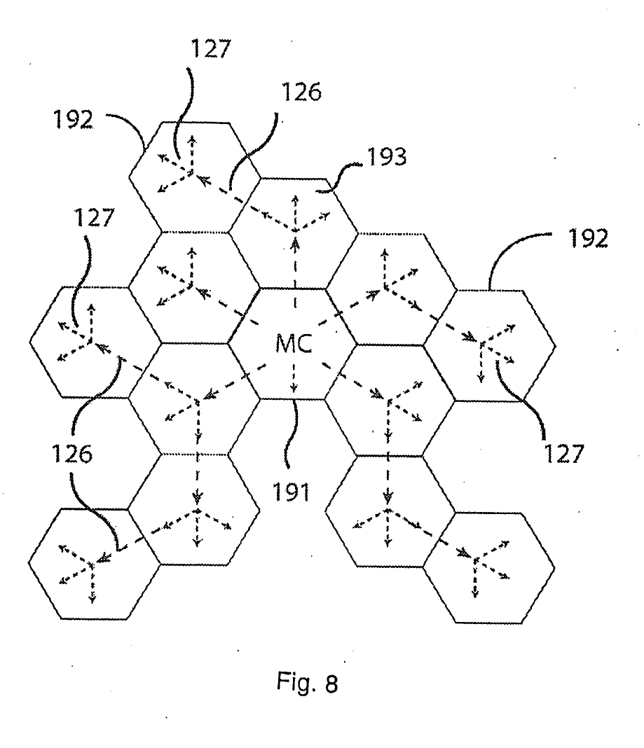

FIG. 8 details communication channels between the cards in a game. The cards may include: master card 191, active slave card 192 and/or inactive slave card 193. According to the topology of the game, there are formed active channels 126 and/or inactive channels 127. Various methods may be used for communications between cards in the game. Following is an example of such a method.

Electronic Card Game (ECG) Communications Protocol. The following is a short description of a communications method: The ECG protocol enables a low bandwidth, half-duplex data transfer over a network comprising a single Master and multiple Slave nodes connected to each other by point-to-point communication links (i.e. all links are electrically isolated; maximum one link is formed between any two nodes).

The number of maximal Slave nodes is limited only by the quality of communication links and the maximal acceptable delays. The specific types of the links (layer 1) is not important besides the fact that a “Start of byte” indication in the received data should be provided for higher layers. It is implied that each Slave node has also a bridging capability with rules specified by the ECG protocol.

Furthermore, the protocol is characterized by: 1) Hot Slave insertion/removal support, including position detection of the new cards; 2) Low propagation delays; 3) Robustness and high noise resistance; 4) Dynamic routing; 5) New cards authentication; 6) Encryption (optional).

Electronic Game Platform

An electronic game platform that supports an interactive card game is described with reference to FIGS. 9A-16. The electronic game platform includes a master 900, bases 1100, and cards 1200. The electronic game platform may also, optionally, include expandable memory cards, a personality module, a game website, and the like. The cards are collectible and contain information about characters, weapons, and the like that are characteristic of the game being played. The cards are inserted into the bases, which are connected to and controlled by the master. The game is controlled by pressing pushbuttons on the bases and the master. Visual and audio effects generated by the master provide game feedback to the players. The master 900 is similar to a game console and the bases 1100 together with the cards 1200 form game tiles.

The electronic game platform recognizes the identity of each card in the game and creates a game plot according to the game rules, card attributes and player feedback. The electronic game platform manages the game mechanics, rules and calculations, so the player can concentrate on the challenges of decision making, strategy formation and the like. The electronic game platform can support many different games by updating the software and different content by changing the playing cards. The electronic game platform promotes direct social interaction during the game, in addition to the social interaction associated with exchanging cards before and after the game.

Master

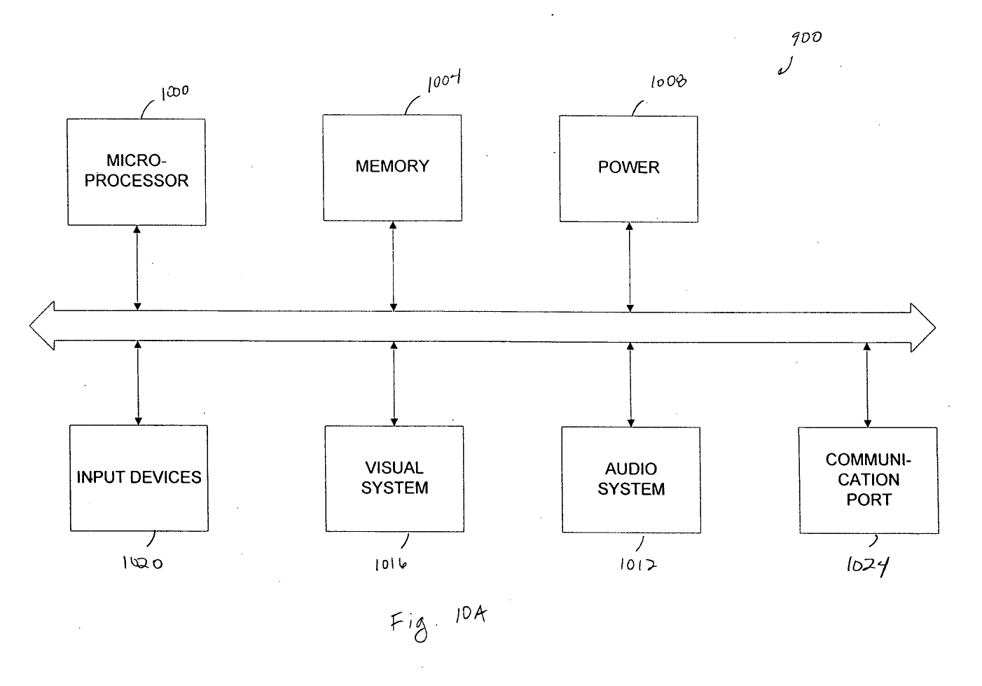

With reference to FIGS. 9A-10B, the master 900 is configured to, for example, distribute power to the bases, monitor the power status of the game platform, manage the communication protocol, monitor the status of each base and card, detect card insertion/removal, register and authenticate bases and cards, monitor pushbuttons at the bases and the master, activate LEDs at the bases and the master, generate special effects, generate sound, implement game rules, manage databases, support serial port communication support, support software downloads, and the like. As will be described in further detail hereinafter, the master 900 may also be configured to, for example, monitor the location of each base card, monitor the identify of each character card, determine the orientation of each character card, determine the relationship between each base and card relative to the other bases and cards in the came, and/or maintain a timeline of the game. In the embodiment shown in FIGS. 9A-16, only one master 900 is needed to operate the game.

As shown in FIGS. 9A and 9B, the master 900 includes a housing 902 having six sets of contacts 904 that are configured for power supply and data exchange. The top surface 908 of the housing 902 includes a user interface. Various user interfaces may be used (e.g., touch screen, etc.). The following description is a description of one example of a user interface according to the embodiment illustrated in FIGS. 9-14. The illustrated user interface includes four pushbuttons 912a-d and ten indication LEDs 916a-j. In one embodiment, the pushbutton 912a is a power and pause button. For example, if the power is OFF and the button 912a is pressed, the power is turned ON, starting the game operation. If the power is ON and the button 912a is pressed for a short period, the game is paused. If the power is ON and the button 912a is pressed for a long period, the power is turned OFF. The buttons 912b and 912c having the ‘+/−’ symbols are configured to set up game parameters, select various menu options, and control the volume level. The button 912d having the ‘>’ symbol is configured to return the game from a Pause mode or to skip stages of the game. In one embodiments, the LEDs 916a-f are configured to specify a parameter value that is being set during set up (e.g., the game level, number of players, current player identification, etc.), identify errors, and/or indicate special visual effects that enhance game play. The LED 916g is configured to indicate a power level. For example, if the LED 916g is lit continuously, the power level is normal; if the LED 916g is blinking, the power level is low. The LED 916h is configured to indicate that the game is paused, the LED 916i is configured to indicate an error, and the LED 916j is configured to supply additional information. The master 900 also includes speakers (not shown) that generate sound effects.

The master 900 also includes hardware within the housing 902 to provide functionality to the master 900. As shown in FIG. 10A, the master 900 includes a microprocessor 1000, memory 1004, power supply 1008, an audio system 1012, a visual system 1016, a user input system 1020 and a communication port 1024. It will be appreciated that the components and arrangement of the components may differ from that shown in FIG. 10A.

The microprocessor 1000 manages the game and controls operation of the bases connected to the master 900. The memory 1004, which may be RAM/ROM, stores the microprocessor program and temporary data. In one embodiment, the power supply 1008 is a battery or batteries with an optional power supply circuit. The battery may be a rechargeable battery, which may be recharged using a regular adapter or via a USB connection. The audio system 1012 generates audio indications and alarms. The visual system 1016 includes the LED's 916a-j that are used for game control and indications. The user input system 1020 includes, for example, pushbuttons, that are used for game control. The communication port 1024 is used for software downloads and data exchange between the master and external devices and the master and the bases.

The audio system 1012 may include, for example, an audio processor, serial memory with preprocessed audio samples, an amplifier, speaker/s, and an audio cavity+audio channels. In one embodiment, the audio processor is a DSP processor capable of polyphonic sound generation. In one embodiment, the processor reads highly compressed audio samples from the external serial memory and applies a decompression algorithm. The resulting analog signal is then amplified by the amplifier and transferred to speakers.

The communication port 1024 communicates with the bases and external computing devices according to a communication protocol. Exemplary communication protocols that can be used with the electronic game platform include, for example, ethernet (TCP/IP), SPI (Serial Peripheral Interface), I2C (Inter-Integrated Circuit), CAN (Controller Area Network), LIN (Local Interconnect Network), RS232, IEE1394 (FireWire), USB (Universal Serial Bus), 1-Wire, I2Net (Intelligent I/O Network), and the like.

The master may also include a memory card slot and a USB connector. The USB connector can be used as a power cable and/or for connecting to a computer to upload or download data to/from the web. The USB port may also be used to recharge the power supply 1008 (i.e., when power supply 1008 is a rechargeable battery). The memory card slot is configured to receive external memory cards. The external memory cards may, for example, enable the addition of new sound effects and rules upgrades supporting the new card releases. The memory cards may be, for example, ROM (Read Only Memory) or Flash cards, which allow for download data from the game internet site and transfer of the data. The master 900 may also include an audio card slot to receive an audio card that enables audio support (e.g., sound and functionality) using the master 900.

With reference to FIG. 10B, the master 900 includes a game engine 1050, a rule database 1054, and a parameter database 1058. The game engine 1050 defines the set of operations that can be performed. Exemplary operations include game setup operation, general game flow control (rounds changing, coordination between other engine components, special audio/light effects generation etc.), audio generation (music, voice announcements and indications etc.), communication protocol implementation, network management (new cards detection, existing cards removal detection, unintentional card resets handling, authentication, message routing etc.), base control (pushbutton monitoring, LED activation), operational/communication errors detection and handling, database management, software upgrade support, and the like. The rules database 1054 stores the rules of the game(s), and the parameter database 1058 stores card identification data, character data, weapon data, and the like. The game engine 1050 accesses the game rules from the rules database 1054 during game play, and generates responses to player input based on the rules from the rules database 1054 and the parameter data stored in the parameters database 1058. In one embodiment, external memory (not shown) may be coupled to the master 900 that includes additional rules, sounds and character data. Exemplary types of external memory include SD memory sticks, Flash memory sticks or keys, and the like.

Bases

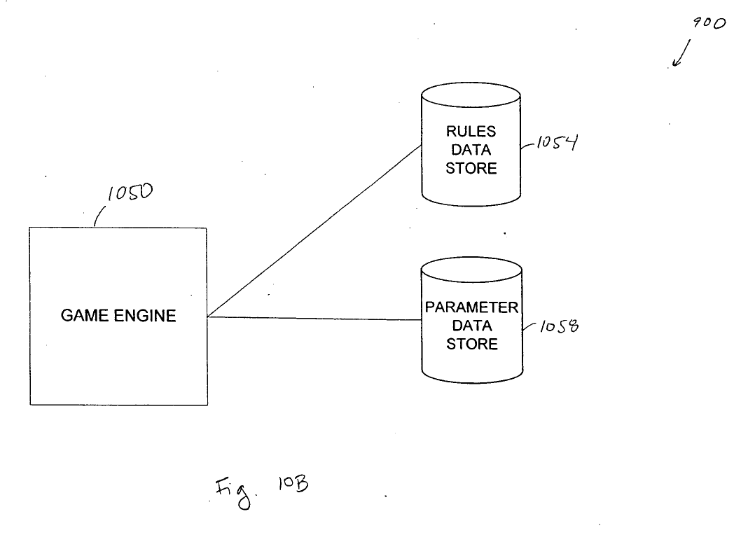

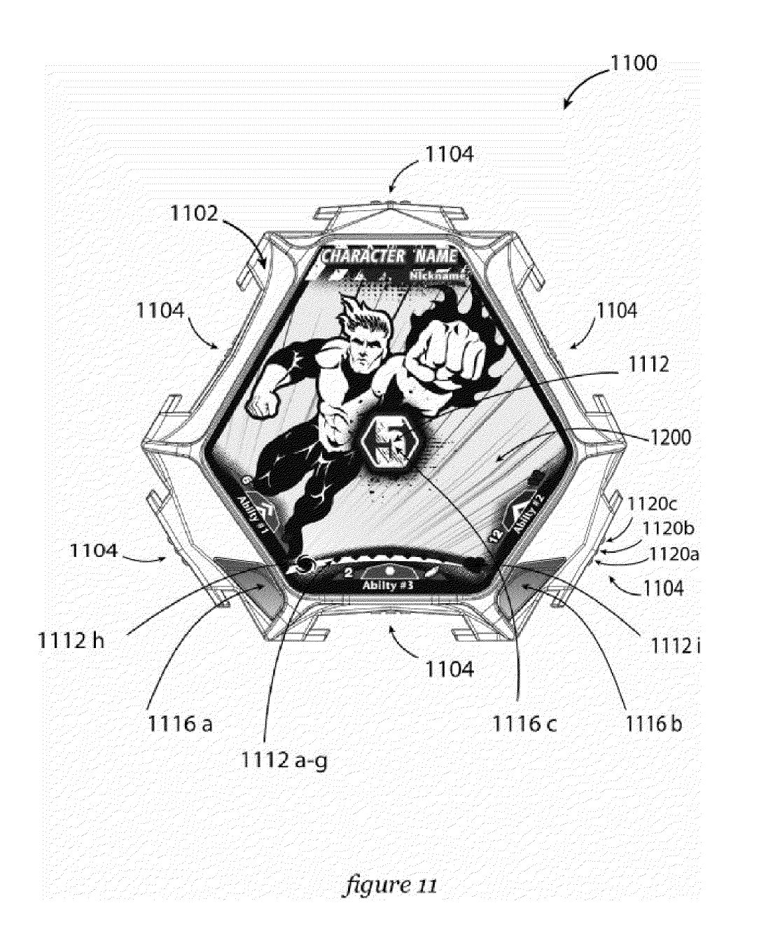

As shown in FIG. 11, the bases 1100 are electronic units which are used to hold and activate the cards 1200. The base 1100 is configured to perform operations such as, for example, monitoring of pushbuttons on the base, activation of LEDs on the base, support the communication protocol, support card registration and authentication, bridge uplink and downlink connections, card identification reading, and, optionally, power support. Bridging between the uplink and downlink connections operations may include, for example, electrical isolation between the uplink and downlink connections, improvement of signal quality, data forwarding between the links, and automatic switching of data direction.

The base 1100 has a housing 1102 that includes connectors 1104 to enable electric and physical connection to other bases or the master, an identification tag reader 1108 (see FIG. 13), and a user interface. The illustrated user interface includes LEDs 1112 and light pipes for visual feedback and buttons 1116 for game control. It will be appreciated that other types of user interfaces may be used or combined with the user interface shown in FIG. 11. The base 1100 also includes electronics that control the above components within the housing 1102. In one embodiment, the electronics that control the base 1100 include an ASIC (without internal RAM and with a reduced number of I/O pins) that controls the on-board electronics and supports communication with the master. In FIG. 11, the housing 1102 of each base 1100 has a hexagonal geometry. It will be appreciated that the housing 1102 may have different shapes. For example, the base 1100 may be triangular, rectangular, round, 3-D, and the like.

The connector 1104 has electrical contacts 1120 on each side that connect the base 1100 to other bases and/or the master. In the illustrated embodiment, the base 1100 does not have an internal power supply; instead, the bases 1100 are powered by the master 900 via contacts 1120; it will be appreciated, however, that the base 100 may include an internal power supply (e.g., a battery). It will also be appreciated that the connector 1104 includes at least three contacts 1120: power (e.g., VCC), GND and Data; however, the connector 1104 may have more than three contacts.

In FIG. 11, the base has three buttons 1116a-c and nine indication LEDs, 1112a-i. In one embodiment, the buttons 1116a-b allow the user to select weapons/actions associated with the card. For example, if the button 1116a is selected, a first option is selected, if the button 1116b is selected, a second option is selected and if both the button 1116a and button 1116b are selected, a third option is selected. The amount of time the buttons 1116a and 1116b is pressed can be used to set a power level of the selected weapon/action. The button 1116c can be used to identify a player associated with each card, specify a target card, request information about a target card, request error information, and the like.

In one embodiment, LEDs 1112a-e are configured to display a current level (e.g., life, energy, weapon, etc.). The LEDs 1112a-e may have different intensity levels (e.g., max power and half power) to display additional status information. The LED 1112f is configured to indicate a life level, and the LED 1112g is configured to identify an energy level. The LED 1112h is configured to identify a positive influence. For example, if the LED is lit permanently, three turns remain; if the LED is blinking with short OFF periods, two turns remain; and, if the LED is blinking with long OFF periods, one turn remains. The LED 1112i is configured to provide a negative influence in a manner similar to the positive influence LED. The LEDs may be provide other visual light effects that have other meanings. For example, if all of the LEDs are off, the card is dead or inactive.

In FIG. 11, the housing 1102 of the base 1100 is hexagonal and has a flat top surface. It will be appreciated that the housing 1102 may have a three-dimensional topology. In addition, the housing 1102 may be a different shape. For example, the housing 1102 may be triangular, rectangular, round, and the like. In another example, each base may have a different shape to correspond to different characters or accessories in the game (i.e., figure-shaped bases).

When a card 1200 is inserted into the base 1100, the identification tag reader 1108 identifies the data about the card 1200 and transmits the data to the master 900. A user can select functionality or characteristics of the card (e.g., actions, weapons, etc.) to play the game by pressing the buttons 1116. The results and effects of each game action are presented by various combinations and sequences of LED 1112 illumination and/or audio feedback. It will be appreciated that the functionality of the user interface elements (e.g. pushbuttons 1116) may change when different cards are inserted into the base 1100. For example, in FIG. 11, the functionality of button 1116a is “web choke” and the functionality of button 1116b is “swinging kick” for a “Spiderman” card. If the “Spiderman” card is replaced with a “Superman” card, the functionality of button 1116a may instead be “laser” and the function of button 1116b may instead be “super punch”. It will also be appreciated that the card 1200 should be configured such that when the card 1200 is inserted into the base 1100, the user interface is accessible. For example, in FIG. 11, the card 1200 includes openings through which the buttons 1116 extend and openings through which the LEDs 1112 are viewable.

In one embodiment, the game platform may include two types of bases: regular bases and accessory (or effects) bases. The regular bases are configured to hold character cards while the accessory bases are configured to hold the accessory cards. The accessory bases may, for example, only be connected at the periphery of the game board and designed to enable fast card insertion/removal. Thus, the accessory bases have only one electrical contact and may have fewer LEDs than the character bases. Alternatively, regular bases can be configured to receive accessory cards (i.e., insertion of an accessory card turns a regular base into an accessory base).

Cards

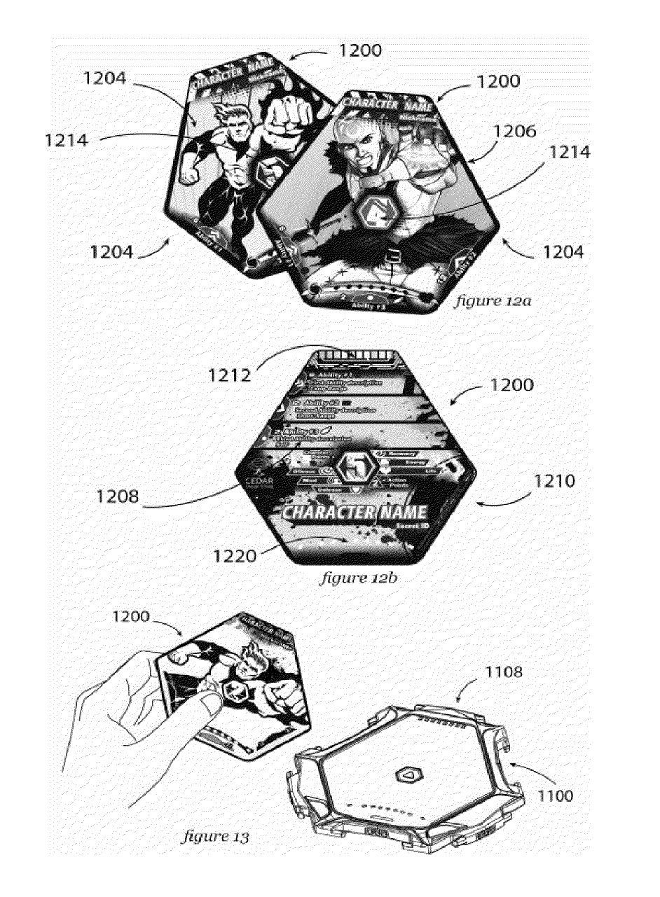

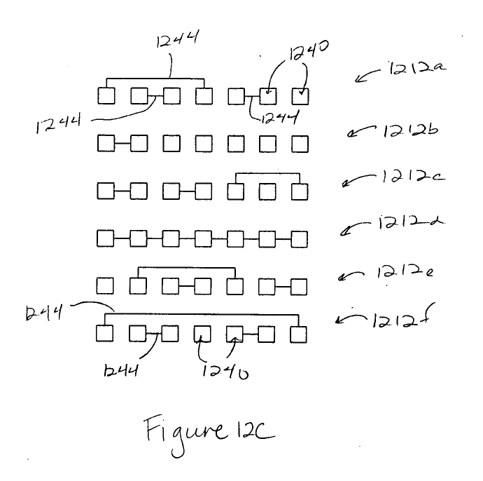

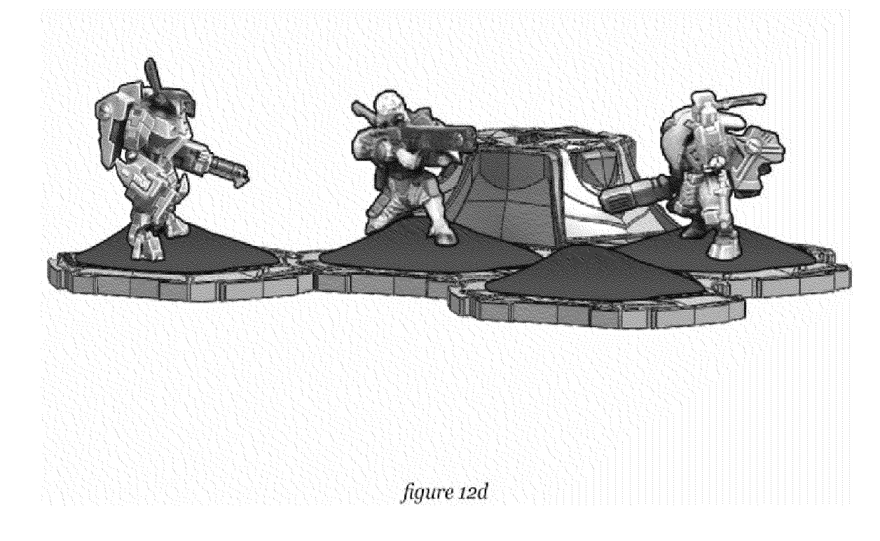

As shown in FIG. 12A, the collectable encoded cards 1200 are playing cards that are printed on a thin (0.5 mm) piece of plastic, paper, or other materials with a colorful visual representation 1204 of the game character or an effect on a front surface 1206 of the card 1200. As shown in FIG. 12B, detailed information 1208 about the card, such as the character's statistics, is located on the back surface 1210 of the card 1200. An identification tag 1212 is also provided on the back surface 1210. The card 1200 is configured to allow access to the user interface of the base 11100. For example, as shown in FIGS. 12A and 12B, the cards 1200 include openings 1216 corresponding to the pushbuttons 1116 of the base 1100 and openings 1220 corresponding to the LEDs 1112 of the base 1100. It will be appreciated that as an alternative to the openings 1220, the card 1200 may include a clear portion through which users can view the LEDs. In one embodiment, two card types are available: character cards and accessory (or effects) cards.

In FIG. 12B, the identification tag 1212 is conductive/resistant paint that is printed on the back side of the card, representing a network of three resistors and four electrical contacts. The conductive paint represents contacts and interconnection lines, and the resistant paint represents identification resistors with predefined values. It will be appreciated that other card identification technologies may be used. Exemplary card identification technologies include, for example, electromechanical identification, physical resistors, printed resistors, ASIC with serial memory, barcode optical reader, ID tag/optical reader, passive RFID tags, magnetic field tags, OTP memory chips (similar to a SIM card) and the like.

FIG. 12C illustrates a conductive contact identification tag technology according to one embodiment of the invention. At least one (even all) of the conductive contacts may be shorted. The shorting configuration provides identity information about each card that can be read by the base 1100 and transmitted to the master 900. Six exemplary conductive contact configurations are illustrated in FIG. 12C. As shown in FIG. 12C, the identification tags 1212a-f include a plurality of conductive contacts 1240. In FIG. 12C, the conductive contacts 1240 are square-shaped; however, it will be appreciated that the conductive contacts 1240 may be other shapes such as, for example, round, linear, rectangular, polygonal and the like. Similarly, although seven contacts 1240 are illustrated, it will be appreciated that fewer than seven or more than seven contacts 1240 may be used. In each illustrated configuration, different conductive contacts 1240 are connected to other ones of the conductive contacts 1240 via shorting connections 1244. As shown in each of the configurations, the shorting connections 1244 vary and each shorting connection can be further varied to provide different identifications. It will be appreciated that other combinations contact shorting connections 1244 may be used to identify different cards. In one embodiment, the conductive contacts 1240 and shorting connections 1244 are made by depositing conductive paint on the card 1200.

As shown in FIG. 12D, the card 1200 may be three-dimensional. For example, as shown in FIG. 12D, the card 1200 may include an action figure representative of a game character associated with the game. In one embodiment, the three-dimensional card 1200 may receive a lighting effect from the base that is reflected in the plastic of the action figure so that it appears that the action figure is providing the feedback directly to the user. In other embodiments, the three-dimensional card 1200 may include electrical components to provide the lighting effect or other user feedback effects. For example, the action figure may include diodes that are electrically connected to the base 1100 and the master 1200. In another example, the action figure may include fiber optics connected to the base to provide the feedback. In yet another example, diodes may be provided in each base 1100 and fiber optics are provided in the action figure to provide the feedback. In a further example, LEDs may be provided in the action figure that are electrically coupled to the base 1100. It will be appreciated that other variations and implementations may be used to provide a feedback effect in a three-dimensional card 1200.

It will be appreciated that as shown in FIG. 12D, the game may include a combination of tile-styled cards and three-dimensional-styled cards. In other embodiments, all of the cards 1200 may be three-dimensional or all of the cards 1200 may be tile-styled.

Connection of Master Bases and Cards

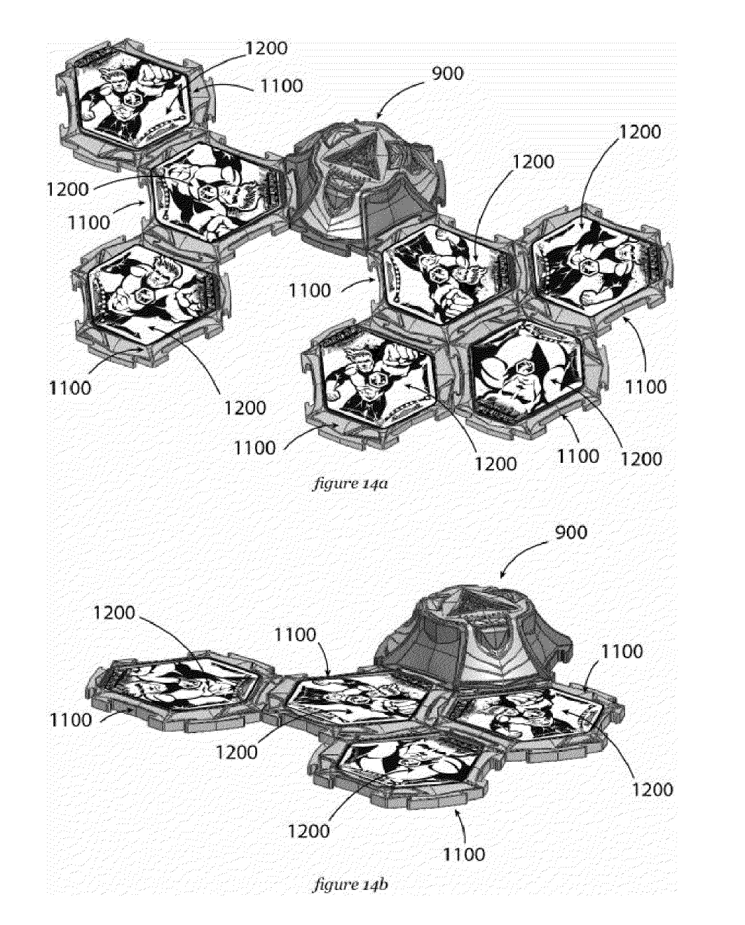

The cards 1200 are connected to the base by attaching the cards 1200 to the top surface of the housing 1102 of the bases 1100 as shown in FIG. 13. The pushbuttons 1116 extend through the openings 1216, and the LEDs 1112 extend through the openings 1220 of the card 1200. The bases 1100 are then connected to the master 900 and/or other bases 1100 as shown in FIGS. 14A and 14B. As shown in FIGS. 14A and 14B, the electronic game platform includes a single master 900 and multiple bases 1100 connected together, each base 1100 having a different playing card 1200. Because the connectors of the master 900 and the base 1100 have the same configuration, the bases and master can be positioned anywhere in the game board. It will be appreciated that in other embodiments the electronic game platform may include multiple masters 900 and multiple bases 1100 connected together.

When the card 1200 is inserted into the base 1100 or the base 1100 is connected to the master 900, the tag 1212 on the card 1200 is read by the reader 1108 in the base 1100. The tag reader detects card insertion and removal and identifies the card identification data. The tag reader may identify the card identification directly or indirectly. For example, if the tag is a resistor, the tag reader may measure the resistance value; in another example, if the tag is a resistor, the tag may measure the time of discharge of a capacitor connected to the resistor (i.e., a parameter proportional to the resistance value). When shortening configuration is used, the reader 1108 comprises several contacts corresponding to card contacts 1240. The base then identifies which of the contacts of reader 1108 are shortened, to thereby determine the identity of the card. The base 1100 transmits the data read from the card 1200 using the identification tag 1212 to the master 900, which converts the data into a card identification at the master 900. The master 900, therefore, knows the identity of each card 1200 in each base 11100.

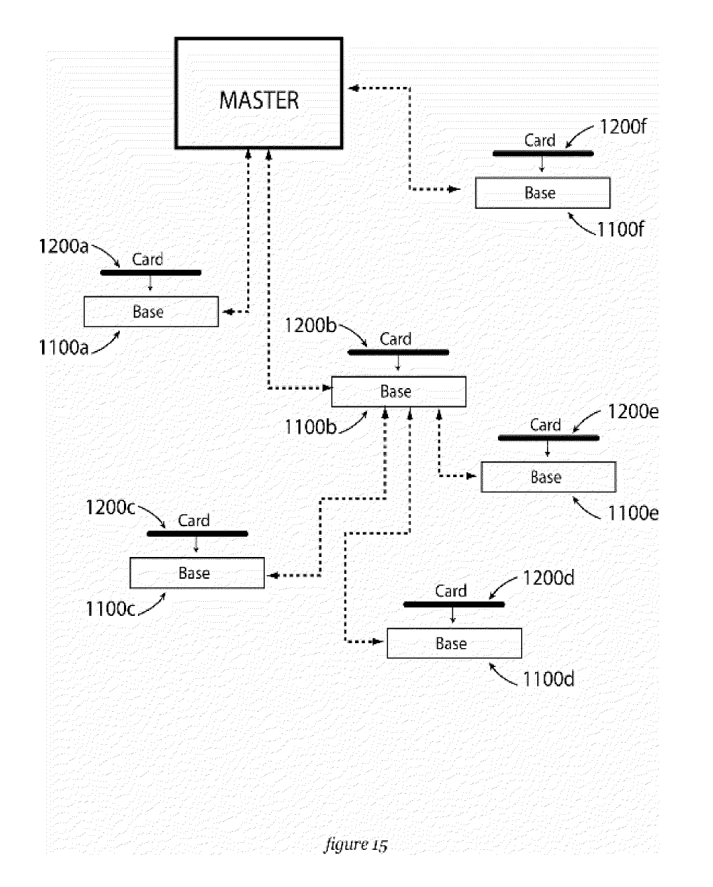

The electronic game platform can be logically divided into up to six sub-networks (e.g., one for each side of the hexagonally shaped master). FIG. 15 illustrates sub-networks for an electronic game platform having three sub-networks. In FIG. 15, three subnetworks 1500a-c are shown. The first subnetwork 1500a includes the master 900, and a first base 1100a and a first card 1200a directly connected to the master 900. The second subnetwork 1500b includes a first base 1100b and a first card 1200b directly connected to the master 900. A second base 1100c and a second card 1100c, a third base 1100d and a third card 1100d, and a fourth base 1100e and a fourth card 1100e are connected to the first base 1100b, which transmits data from the second base 1100c, third base 1100d and fourth base 1100e to the master 900. The third subnetwork 1500c includes a first base 1100f and a first card 1200f directly connected to the master 900.

In the embodiment of FIGS. 9-14, the master 900 provides power to all of the bases 1100. Bases that are not directly connected to the power receive power from the base through adjacent bases. If a base is connected to multiple bases, the base will receive power from the multiple bases. Data is also transferred from the master 900 to the bases 1100 and vice versa. In one embodiment, data is transferred only within each sub-network 1500; it will be appreciated that all of the power and GND contacts may still be interconnected to improve system robustness. The master 900 can calculate the coordinates of each base 1100 relative to the master 900 and the distances between the master 900 and each base 1100. In one embodiment, the functionality of the cards 1200 are affected by the position of the card within the electronic game platform. The master 900 can also calculate the orientation of each base (and, therefore, the orientation of each card) relative to each other base in the game.

Game Setup

After the cards 1200 are connected to the bases 1100 and the bases 1100 are connected to the master 900, the master 900 operates a game setup operation. The game set up operation includes power on, setting the game level, setting the number of players, selecting bases and adding bases. It will be appreciated that the set up operation may have different steps and may perform the steps in a different order than described herein.

The power on operation begins with a player selecting the pushbutton 912a on the master 900. In one embodiment, a game introduction announcement may be played by the master 900.

After the game introduction, the game setup operation may proceed to a setting the game level operation. Players may select a game level by pressing the pushbuttons 912b-c and the pushbutton 912d on the master 900. Exemplary game levels include: Level_{—}1: long turns, long LED update periods, no reinforcements, and 25 sec turnout; Level_{—}2: long turns, long LED update periods, reinforcements according to master notification only, and 20 sec turnout; Level_{—}3: short turns, short LED update periods, reinforcements according to master notifications only, and 16 sec turnout; and, Level_{—}4: short turns, short LED update periods, reinforcements at any time during the turn, and 12 sec turnout.

The game setup operation continues by setting the number of players. Players can select the number of players by pressing the pushbuttons 912b-c and the pushbutton 912d on the master 900.

The game setup operation then continues to a base selection operation. If no bases are connected to the master, the game setup operation continues to the base addition operation. The base selection operation allows each player to select his/her bases in the electronic game platform. After a player selects all of his/her bases, the next player selects his/her bases until all of the bases have been selected.

In the base addition operation, each player can add a new base during his/her turn. This base is automatically associated with the player that added the base. After all of the bases have been added and assigned to the players, the master 900 initiates the game play operations.

Game Play

The game is played in turns. During each turn, each player tries to defeat opponents by using the abilities of the character card or by inserting accessory cards. During each turn, the player “attacks” other bases or gets information about each base. In one embodiment, a player attacks other bases by choosing an attacking base, choosing a target base, selecting a weapon, and selecting a power level by pressing pushbuttons 1116a-c at the base 1100. The selections are transmitted from the base 1100 to the master 900. The master 900 considers, for example, the character's unique abilities stored in the parameter database, the rules of the game stored in the rules database, and the distance between the bases to determine the outcome of the action. Appropriate LED indications and/or sound effects at the base and/or master provide feedback to the players with each turn. During the game, the master 900 may also maintain a timeline of the game. The master 900 can use the timeline to adjust a character's abilities (e.g., a character may be stronger when it is younger because its physical strength is higher, a character may be stronger when it is older because its wisdom is higher, a character may be weaker when it is too young and/or too old, etc.)

The game ends when all the enemy cards are eliminated or all of the cards are controlled by a single player. In one embodiment, a typical game lasts between about 15-30 minutes, depending on the number of players and characters used. It will be appreciated that the duration of the game may be less than 15 minutes or more than 30 minutes.

It will be appreciated that the game setup and game play described herein are merely exemplary and that other methods of setting up the game and playing the game are envisioned.

Personality Module

The electronic game platform optionally includes a personality module. The optional personality module records user specific information and displays user information when required (including off-line information). The personality module may also be configured to support user-defined custom cards. The personality module may have a shape similar to the base 1100 and electrical contacts on only one side to connect the personality module to an edge of the game system (e.g., to an outlying base or a side of the master not connected to any bases). The personality module includes an internal battery and a display (e.g., an LCD having 2-3 lines with backlight) for displaying digits and characters. The personality module may also include a mini-USB port, or other connector, to directly connect the personality module to an external computer.

Internet Game Site

The game platform may also include an Internet game site accessible through an Internet browser on a personal computer (or PDA, cellular phone or other computing device having Internet accessible features). The computer may be connected to the master 900 to update the game (e.g., game rules, card attributes), etc, and/or to receive game data. For example, the Internet game site can be used to track player data and the results of games. The computer and master 900 may be connected through, for example, a USB connector, a wireless connection, etc. Alternatively, data may be transferred through a flash memory device.

In one embodiment, the Internet game site includes a background story, documentation (e.g., a full catalog of heroes and accessories), manuals, a demo of weapon activation including visual lights and sound effects, advertisements (e.g., previews of future cards and game options, expected release dates, competitions, shows etc.), a personal player page, a game demo with introduction to general game operation, audio tracks download support, a player's forum to answer questions and get player feedback, FAQ's, an online store, a store locator, a link to an owner's home directory, partner links, and the like.

In one embodiment, the personal player page includes personal data that is displayed to other players (nick name, photo or icon, etc.), a virtual card album, access to other players' albums, virtual cards exchange, access to a members' only area (articles, tips and tricks, etc.), a general players rating, an FAQ and members area, automatic updates, and the like. In one embodiment, the player's page is created automatically after registration. Players can add newly purchased cards to their virtual album.

Game Simulator

The game platform may also include a game simulator that is connectable to the master 900. The game simulator is software that runs on an external computer and enables development and testing of new game applications. The simulator can be used to define and test new cards, define and test new game applications, define and update new rules for existing applications, update and test the game engine, and the like.

Advantages

One exemplary advantage of the electronic game platform is that it provides a foundation for the implementation of potentially endless content and applications, aimed at different audience, age groups, and uses and even different physical interfaces. The electronic game platform can support both educational and entertainment applications, which can be adapted with a variety of types of cards as well as other types of collectable elements (e.g., 3D figures) that feature various story lines and/or franchises (e.g., Harry Potter, Disney themes, Superman, Star Wars, Spiderman, Pokemon, etc.). Another advantage is that the game rules and parameters are stored in the master. Thus, players are not required to memorize the game rules or perform tedious manual calculations or bookkeeping. Instead, players are able to focus on creativity and strategic intelligence. In addition, the electronic game platform provides improved social interaction. Players socialize during actual game play, but also before and after game play through the collecting and trading of the game cards. In addition, because the electronic game platform does not require a display screen, eye contact between players is not blocked, which paves the way for interesting social transactions that form alliances and bonds.

Unless specifically stated otherwise, throughout the present disclosure, terms such as “processing”, “computing”, “calculating”, “determining”, or the like, may refer to the actions and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include an apparatus for performing the operations therein, such as the electronic controller 171 in FIG. 2. Such apparatus may be specially constructed for the desired purposes, or it may comprise a general-purpose computer selectively activated or reconfigured by a computer program stored in the computer.

A computer program for implementing embodiments of the invention may be stored in a computer-readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions or data, and capable of being coupled to a computer system bus.

It should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention.

The present invention has been described in relation to particular examples, which are intended in all respects to be illustrative rather than restrictive. Those skilled in the art will appreciate that many different combinations of hardware, software, and firmware will be suitable for practicing the present invention. Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. An electronic card game system comprising:
a master controller;
a plurality of bases, each of the plurality of bases connectable to the master controller or one or more of the plurality of bases; and
a plurality of cards, each card connectable to respective ones of the plurality of bases.

2. The system of claim 1, wherein each of the plurality of bases comprises a processor operable to receive a transmission from another base and relay the transmission.

3. The system of claim 1 wherein each of the bases comprises connectors configured to receive power from the master and concurrently or alternatively receive power from another base.

4. The system of claim 1, wherein each of the plurality of cards comprises an identifier readable by the bases.

5. The system of claim 4, wherein each of the plurality of bases comprises an identifier reader to read the identifier on each of the plurality of cards and wherein the base is configured to relay the identifier to the controller.

6. The system of claim 4, wherein the identifier is one of optical, resistive paint an RFID tag and conductive shorts.

7. The system of claim 1 wherein the master controller stores at least one of data regarding each of the plurality of cards and rules for playing the electronic card game.

8. The system of claim 1 wherein the bases are configured to at least one of relay game commands to the master controller, receive the game commands and calculates consequences and indicate consequences audibly, visually, or audibly and visually.

9. A master card for an electronic card game comprising:
a rules data memory to store a plurality of rules for the electronic card game;
a parameter data memory to store parameter data regarding each card associated with the electronic card game; and
a game engine coupled with the rules data memory and the parameter data memory to: detect slave cards coupled with the master card, receive parameter information from the slave cards, receive card identification information from the slave cards, receive user input data from the slave cards, process the user input data using at least one of the plurality of rules and the parameter data, identify a result, and issue an indication of the result.

10. The master card of claim 9 wherein the game engine further transmits the result to at least one of the slave cards.

11. The master card of claim 9 further comprising a communications link coupled with the processor, the communications link configured to allow for communication between the master card and the slave cards.

12. The master card of claim 9 further comprising a communications link coupled with the processor, the communications link configured to allow for communication between the master card and an external computing device and wherein the external computing device is selected from the group consisting of a personal computer, a server and a mobile device.

13. The master card of claim 9 further comprising a user interface coupled with the game engine, the user interface configured to receive user input wherein the user interface comprises at least one button.

14. The master card of claim 13 wherein the user interface comprises an indicator to provide information to a user, and wherein the indicator comprises a visual indicator, an audio indicator or a visual indicator and an audio indicator.

15. A slave card for an electronic card game comprising:
a housing configured to receive a playing card;
an identification reader in the base structure to identify the card;
a plurality of electrical connectors to electrically connect the base structure with a master controller or another base structure; and
a user interface on the base structure.

16. The slave card of claim 15 further comprising a processor structured to communicate with the master controller.

17. The slave card of claim 15 wherein the user interface comprises one or more of at least one button and a plurality of indicators, wherein the plurality of indicators comprise visual indicators, audio indicators or visual indicators and audio indicators.

18. The slave card of claim 15 wherein the identification reader comprises one or more of an optical reader and electrical contacts.

19. The slave card of claim 15 wherein the electrical connectors comprise at least a power line and a data line.

20. The slave card of claim 15 wherein the playing card comprises an action figure.

21. A master card for an electronic card game comprising:
a housing;
a controller in the housing; and
a plurality of electrical connectors coupled with the controller, the plurality of electrical connectors to electrically connect the master card with a plurality of bases, the electrical connectors configured to supply power and data to the bases.

22. The master card of claim 21 further comprising a user interface on the housing.

23. The master card of claim 21 wherein each of the plurality of electrical connectors comprise at least a power contact, a ground contact and a data contact.

24. A system comprising
a plurality of cards;
a plurality of bases, the plurality of cards configured to be coupled with a respective plurality of the plurality of bases;
a master controller, the plurality of bases configured to be coupled to the master controller, the master controller configured to exchange data with each of the plurality of bases, and
wherein the plurality of bases are configured to receive user input at one of the plurality of bases and communicate the user input to the master controller, and
wherein the master controller is configured to process the user input at the master controller based on at least one rule stored at the master controller to determine a result and provide an indication of the results

25. The system of claim 24 wherein the master controller transmits the result to at least the one of the plurality of bases.

26. The system of claim 24 wherein each of the plurality of cards comprises an identification code and wherein each of the plurality of bases comprises an identification reader.

27. The system of claim 24 wherein the master controller comprises a user interface and wherein each of the plurality of bases comprises a user interface, the plurality of bases configured to receive the user input at the user interface of the plurality of bases.

28. A playing card comprising:
a planar card;
an identification code on a surface of the card; and
a graphical design on an opposite surface of the card.

29. The playing card of claim 28 wherein the identification code is optically recognizable or comprises conductive shorts.

30. The playing card of claim 28 wherein the graphical design comprises game data associated with the playing card.

31. The playing card of claim 28 wherein the identification code is configured to provide data about the playing card to a master controller coupled with the playing card.

32. The playing card of claim 28 wherein the surface of the card having the identification code further comprises a graphical design.
